(19) United States
(12) Patent Application Publication
(10) Pub. No.: US 2026/0131821 A1
(43) Pub. Date: May 14, 2026

(54) METHOD OF EXTRACTING BIRD'S EYE VIEW FEATURE AND AUTONOMOUS DRIVING METHOD UTILIZING THE SAME

(71) Applicants: SAMSUNG ELECTRONICS CO., LTD., Suwon-si (KR); KOREA ADVANCED INSTITUTE OF SCIENCE AND TECHNOLOGY, Daejeon (KR)

(72) Inventors: Minki JEONG, Suwon-si (KR); Junmo KIM, Daejeon (KR); Jongsuk KIM, Daejeon (KR); Jae Young LEE, Daejeon (KR); Dong-Jae LEE, Daejeon (KR); Gyojin Han, Daejeon (KR)

(73) Assignees: SAMSUNG ELECTRONICS CO., LTD., Suwon-si (KR); KOREA ADVANCED INSTITUTE OF SCIENCE AND TECHNOLOGY, Daejeon (KR)

(21) Appl. No.: 19/189,935

(22) Filed: Apr. 25, 2025

(30) Foreign Application Priority Data
Nov. 14, 2024 (KR) 10-2024-0162460
Jan. 9, 2025 (KR) 10-2025-0003516

(51) Int. Cl. B60W 60/00; B60W 30/16; B60W 50/00; G06V 10/82

(52) U.S. Cl. CPC B60W 60/001; B60W 30/16; B60W 50/0097; G06V 10/82; B60W 2050/0083; B60W 2520/06; B60W 2520/10; B60W 2554/80; B60W 2556/40; B60W 2556/50

(57) ABSTRACT

A method of extracting a bird's eye view (BEV) feature includes generating, from a diffusion model, a driving scenario of a vehicle, based on guide information, inferring, using a pre-trained neural network, at least one BEV feature corresponding to the at least one piece of map data by inputting the at least one piece of map data to the pre-trained neural network, and setting a path of an autonomous driving model based on the at least one BEV feature, the autonomous driving model controlling a driving operation of the vehicle. The driving scenario includes the at least one piece of map data.

### CROSS-REFERENCE TO RELATED APPLICATIONS

This application claims priority under 35 U.S.C. § 119 to Korean Patent Application No. 10-2024-0162460, filed on Nov. 14, 2024, and Korean Patent Application No. 10-2025-0003516, filed on Jan. 9, 2025, in the Korean Intellectual Property Office, the disclosures of which are incorporated by reference herein in their entireties.

### BACKGROUND

### 1. Field

The present disclosure relates generally to autonomous driving, and more particularly to, a method of extracting a bird's eye view (BEV) feature and an autonomous driving method utilizing the same.

### 2. Description of Related Art

End-to-end autonomous driving technology may extract the movement of an object such as, but not limited to, a vehicle and/or a person, from a bird's-eye view (BEV) feature that may have been obtained from a multi-view camera image, may determine whether a vehicle occupies a road (e.g., in units of two-dimensional (2D) spaces), and may generate an autonomous driving path by determining a next driving path of the vehicle based on the extracted movement.

Developments in end-to-end autonomous driving technology, similarly to developments in deep learning technology, may be constrained by availability of driving data sets that may be used to train autonomous driving and/or deep learning models. For example, generation of the driving data sets may depend on using actual data sets, and as such, training using actual scenarios may be limited due to, for example, safety issues and/or concerns, practical constraints, or the like.

A camera-based autonomous driving scheme may include implementation of planning-oriented autonomous driving (UniAD), which may configure one or more processing modules for perception, prediction, and/or planning in stages. For example, a vehicle that is a subject of autonomous driving may be equipped with multiple (e.g., six (6)) cameras, and BEV features may be encoded through images captured by the cameras and utilized by each of the processing modules. An exemplary UniAD algorithm may be configured to arrange the processing modules in series, such that each processing module may utilizes an output of a previous processing module.

In addition, guided conditional diffusion for controllable traffic simulation (CTG) may propose technology for generating a multi-agent driving scenario in an actual driving environment. CTG may refer to technology for learning a driving scenario generation model similar to actual driving based on a diffusion model and generating a result that may include a location and/or rotation information of each agent at each timepoint.

### SUMMARY

One or more embodiments may address at least one of the above problems and/or disadvantages, as well as, other disadvantages not described above. In addition, the embodiments may not necessarily overcome the disadvantages described above, and an embodiment may not overcome any of the problems described above.

According to an aspect of the present disclosure, a method of extracting a bird's eye view (BEV) feature includes generating, from a diffusion model, a driving scenario of a vehicle, based on guide information, inferring, using a pre-trained neural network, at least one BEV feature corresponding to the at least one piece of map data by inputting the at least one piece of map data to the pre-trained neural network, and setting a path of an autonomous driving model based on the at least one BEV feature, the autonomous driving model controlling a driving operation of the vehicle. The driving scenario includes the at least one piece of map data.

In an embodiment of the method, the generating of the driving scenario of the vehicle may include obtaining, from the diffusion model for a predetermined time period, movement data corresponding to at least one timestamp, and generating the driving scenario by synthesizing map data that displays the movement data on a map, based on the at least one timestamp. The movement data may include a location of the vehicle, a speed of the vehicle, and a direction of the vehicle.

In an embodiment of the method, the generating of the driving scenario of the vehicle may include generating the driving scenario based on the guide information including at least one of a maximum speed limit of the vehicle, a destination of the vehicle, or vehicle signal settings during driving of the vehicle.

In an embodiment of the method, the generating of the driving scenario of the vehicle may include generating the driving scenario based on the guide information including a weight setting for positioning the vehicle on a road within a map and a setting for maintaining a distance from other vehicles.

In an embodiment of the method, the inferring of the at least one BEV feature may include extracting the at least one BEV feature corresponding to at least one timestamp included in the driving scenario.

In an embodiment, the method may further include obtaining the pre-trained neural network by training a neural network using a loss function based on a difference between a first BEV feature of the map data and a second BEV feature of a multi-view camera image corresponding to the map data.

In an embodiment, the method may further include training, by using the at least one BEV feature, at least one neural network from among a plurality of neural networks including a first neural network configured to detect movement of a surrounding vehicle around the vehicle, a second neural network configured to predict an occupancy of a surrounding road and an operation of the surrounding vehicle, and a third neural network configured to determine a next moving path of the vehicle.

In an embodiment, the method may further include training the third neural network using a loss function based on a difference between the at least one BEV feature, a first BEV feature of a multi-view camera image, and a second BEV feature of map data corresponding to the multi-view camera image.

In an embodiment, the method may further include training the first neural network using a first loss function based on a first difference between a first BEV feature of a multi-view camera image and a second BEV feature of map data corresponding to the multi-view camera image, and training the second neural network using a second loss function based on a second difference between the first BEV feature, the second BEV feature, and a third BEV feature of generated map data corresponding to the multi-view camera image.

In an embodiment of the method, the training of the second neural network may include obtaining the at least one piece of map data by converting a coordinate system around the vehicle, and inputting the at least one converted piece of map data to the second neural network.

According to an aspect of the present disclosure, a method of training a first neural network for extracting a BEV feature includes obtaining a multi-view camera image and map data for a timestamp corresponding to a location on a map, obtaining a first BEV feature of the map data by inputting the map data to a second neural network, obtaining a second BEV feature of the multi-view camera image by inputting the multi-view camera image to a third neural network, and training the first neural network using a loss function based on a difference between the first BEV feature of the map data and the second BEV feature of the multi-view camera image.

In an embodiment of the method, the training of the first neural network may include training the first neural network by inputting a BEV feature query of the first neural network to the third neural network as a query of the third neural network.

According to an aspect of the present disclosure, a device for extracting a BEV feature includes one or more processors including processing circuitry, and memory storing instructions. The instructions, when executed by the one or more processors individually or collectively, cause the device to generate, using a diffusion model, a driving scenario of a vehicle based on guide information, infer, using a pre-trained neural network, at least one BEV feature corresponding to the at least one piece of map data by inputting the at least one piece of map data to the pre-trained neural network, and set a path of an autonomous driving model based on the at least one BEV feature, the autonomous driving model controlling a driving operation of the vehicle. The driving scenario includes at least one piece of map data.

The instructions, when executed by the one or more processors individually or collectively, may further cause the device to obtain, from the diffusion model for a predetermined time period, movement data corresponding to at least one timestamp, and generate the driving scenario by synthesizing map data that displays the movement data on a map, based on the at least one timestamp. The movement data includes a location of the vehicle, a speed of the vehicle, and a direction of the vehicle.

The instructions, when executed by the one or more processors individually or collectively, may further cause the device to generate the driving scenario based on the guide information including at least one of a maximum speed limit of the vehicle, a destination of the vehicle, or settings of signals of the vehicle during driving.

The instructions, when executed by the one or more processors individually or collectively, may further cause the device to generate the driving scenario based on the guide information including a weight setting for positioning the vehicle on a road within a map and a setting for maintaining a distance from other vehicles.

The instructions, when executed by the one or more processors individually or collectively, may further cause the device to extract the at least one BEV feature corresponding to at least one timestamp included in the driving scenario.

The instructions, when executed by the one or more processors individually or collectively, may further cause the device to obtain the pre-trained neural network by training a neural network using a loss function based on a difference between a first BEV feature of the map data and a second BEV feature of a multi-view camera image corresponding to the map data.

The instructions, when executed by the one or more processors individually or collectively, may further cause the device to train, by using the at least one BEV feature, at least one neural network from among a plurality of neural networks including a first neural network configured to detect movement of a surrounding vehicle around the vehicle, a second neural network configured to predict an occupancy of a surrounding road and an operation of the surrounding vehicle, and a third neural network configured to determine a next moving path of the vehicle is trained by using the at least one BEV feature.

The instructions, when executed by the one or more processors individually or collectively, further cause the device to train the third neural network using a loss function based on a difference between the at least one BEV feature, a first BEV feature of a multi-view camera image, and a second BEV feature of map data corresponding to the multi-view camera image.

Additional aspects may be set forth in part in the description which follows and, in part, may be apparent from the description, and/or may be learned by practice of the present disclosure.

### BRIEF DESCRIPTION OF THE DRAWINGS

The above and/or other aspects, features, and advantages of certain embodiments of the present disclosure may be more apparent from the following description taken in conjunction with the accompanying drawings, in which:

FIG. 1 is a diagram illustrating a method of generating a synthesized driving scenario, according to an embodiment;

FIG. 2 is a flowchart illustrating a method of generating a bird's-eye view (BEV) feature from a driving scenario, according to an embodiment;

FIG. 3 is an example of a driving scenario generated by a diffusion model, according to an embodiment;

FIG. 4 is a diagram conceptually illustrating training of a neural network for extracting a BEV feature from a synthesized driving scenario, according to an embodiment;

FIG. 5 is a flowchart illustrating a method of training a neural network for inferring a BEV feature from map data, according to an embodiment;

FIG. 6 is a diagram illustrating training of a neural network that infers a BEV feature from map data, according to an embodiment;

FIG. 7 is a diagram illustrating a method of utilizing, for an autonomous driving neural network, a BEV feature inferred from map data, according to an embodiment;

FIG. 8 is a block diagram illustrating a device for inferring a BEV feature from a driving scenario, according to an embodiment; and

FIGS. 9A and 9B are diagrams illustrating performance of an example of generating a driving scenario, according to an embodiment.

### DETAILED DESCRIPTION

Hereinafter, various embodiments of the present disclosure are described with reference to the accompanying drawings. However, various alterations and modifications may be made to the embodiments. For example, the embodiments may not be limited by the descriptions of the present disclosure. That is, the embodiments may be understood to include all changes, equivalents, and replacements within the idea and the technical scope of the present disclosure.

The terminology used herein may describe particular examples only and may not limit the embodiments. The singular forms “a,” “an,” and “the” may include the plural forms as well, unless the context clearly indicates otherwise. It may be further understood that the terms “comprises/comprising” and/or “includes/including,” when used herein, may specify the presence of stated features, integers, steps, operations, elements, and/or components, but may not preclude the presence and/or addition of one or more other features, integers, steps, operations, elements, components and/or groups thereof.

Unless otherwise defined, all terms including technical or scientific terms used herein may have the same meaning as those commonly understood by one of ordinary skill in the art to which the examples belong. Terms, such as those defined in commonly used dictionaries, may be interpreted as having a meaning that is consistent with their meaning in the context of the relevant art and the present disclosure, and may not be interpreted in an idealized or overly formal sense unless expressly so defined herein.

When describing the examples with reference to the accompanying drawings, like reference numerals may refer to like components and a repeated description related thereto may be omitted for the sake of brevity. In the description of embodiments, detailed description of well-known related structures and/or functions may be omitted when deemed that such descriptions may cause ambiguous interpretation of the present disclosure.

In the description of the components of the embodiments, terms such as first, second, A, B, (a), (b), or the like may be used. These terms may only be used for discriminating one component from another component, and the nature, the sequences, and/or the orders of the components may not be limited by the terms. It is to be understood that when a component is described as being “connected,” “coupled,” or “joined” to another component, the former may be directly “connected,” “coupled,” or “joined” to the latter or “connected,” “coupled,” or “joined” to the latter via another component.

The same name may be used to describe components having a common function in different embodiments. Unless otherwise indicated, the description of one embodiment may be applicable to another embodiment. Thus, duplicated descriptions may be omitted for the sake of brevity.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

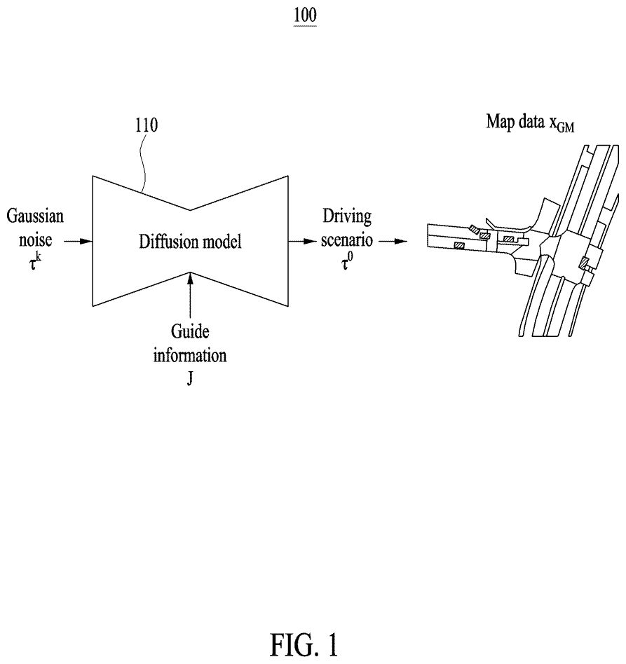

FIG. 1 is a diagram illustrating a method of generating a synthesized driving scenario, according to an embodiment. Referring to FIG. 1, a method 100 of generating a synthesized driving scenario is illustrated.

A driving scenario τ⁰ may be generated using a pre-trained diffusion model 110. The diffusion model 110 may be trained by inputting map information for a scenario as a condition.

The driving scenario τ⁰ may be obtained by inputting Gaussian noise τ^{k} to the pre-trained diffusion model 110. The driving scenario τ⁰ may be generated by obtaining movement data for a scene at each timestamp at a predetermined time interval (e.g., 2 Hz) for a predetermined period of time (e.g., 10 seconds) and synthesizing the movement data to connect into one scenario. However, the present disclosure is not limited in this regard, and the driving scenario τ⁰ may be generated by obtaining movement data at another fixed and/or variable time interval and/or for another period of time. The movement data may represent a location of a vehicle, a speed of the vehicle, a direction of the vehicle, or the like for each object included in the scene.

The driving scenario τ⁰ may be generated by synthesizing map data x_{GM}, which may display on a map the movement data included in a scene at each timestamp at which scenes within the entire time of the scenario are obtained.

The driving scenario τ⁰ obtained from the diffusion model 110 may be generated according to rules included in guide information J. The guide information J may be reflected, for example, by adding a condition based on driving guide information and/or by giving a weight to a loss function so that vehicles in the driving scenario τ⁰ may drive in a manner consistent with common sense (e.g., on the road, within a lane, in a correct direction, at or below a posted speed, or the like).

The guide information J for the driving scenario τ⁰ may include, but not be limited to, a vehicle speed limit, destination settings, and settings of signal information during driving.

Alternatively or additionally, the guide information J may further control rules for preventing a collision between vehicles. For example, approximate objects may be used for objects appearing in the driving scenario τ⁰ to detect vehicle collisions. Collisions between vehicles may be prevented based on a predetermined margin distance. In training, vehicles may be controlled so that collisions between the vehicles may be prevented by pre-setting a weight for a collision loss function that may represent collisions between vehicles.

The guide information J may further include information to control vehicles from leaving a road section of a map, as well as, information to control vehicles. For example, a number of points (e.g., in a length direction and a width direction respectively) that may sampled to detect map collisions within a bounding box of a driving vehicle may be set, and a weight of a map collision loss function may be set to limit map collisions during training so as not to collide with corresponding points, thereby providing for the vehicle to drive (travel) on the road section. Based on a sampling process of the diffusion model 110, various traffic situations may be implemented so that a movement path of the vehicle may satisfy the guide information J.

The diffusion model 110 may be and/or may include a diffusion-based neural network that may be trained (e.g., through deep learning) to progressively diffuse samples with random noise, and reverse the diffusion process to generate an image with a relatively high quality. For example, the diffusion model 110 may be and/or may include, but not be limited to, a variational autoencoder (VAE), a generative adversarial network (GAN), an autoregressive model, or the like. However, the present disclosure is not limited in this regard.

In an embodiment, the diffusion model 110 may start with random noise (e.g., Gaussian noise τ^{k}), and the noise may be gradually removed over a predetermined number of stages included in the diffusion model 110. In an embodiment, a conditional diffusion model 110 may be used to reflect the guide information J. The guide information J may include a plurality of conditions and may be determined based on a weighted sum for each condition. A condition may be applied to a noise removal process of the diffusion model 110 by applying a gradient to the guide information J.

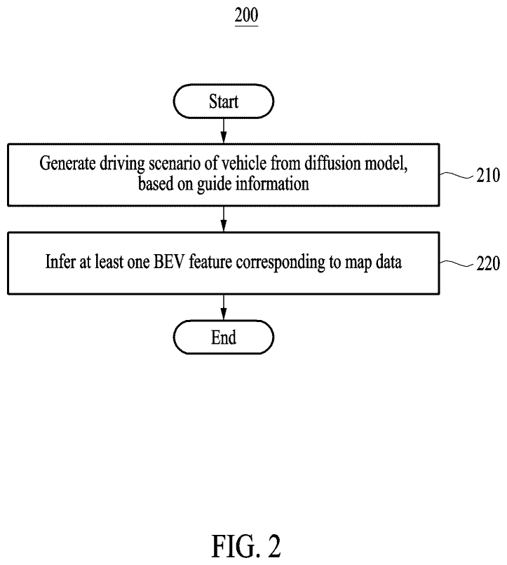

FIG. 2 is a flowchart illustrating a method of generating a bird's-eye view (BEV) feature from a driving scenario, according to an embodiment. Referring to FIG. 2, a method 200 of generating a BEV feature from a driving scenario τ⁰ is illustrated.

Operations to be described hereinafter may be performed sequentially but not necessarily. For example, the order of the operations may be changed, and at least two of the operations may be performed in parallel.

An autonomous driving model may be improved by using a synthesized driving scenario for training the autonomous driving model. For example, an ego vehicle being controlled or simulated by the autonomous driving model may be designated in the synthesized driving scenario, and a driving scenario τ⁰ centered on the ego vehicle may be generated. A BEV feature may be obtained by using generated map data x_{GM} that may project the generated driving scenario τ⁰ onto a map, and the BEV feature may be utilized for training the autonomous driving model.

The BEV feature may refer to, for example, information in which each point within a predetermined 256×256 space has 200 dimensions.

In operation 210, a device may generate a driving scenario τ⁰ of a vehicle (e.g., the ego vehicle) from the pre-trained diffusion model 110, based on the guide information J.

In an embodiment, the device may obtain movement data from the diffusion model 110 trained with a map condition at a predetermined time interval for a predetermined period of time. The movement data may represent a scene showing a movement of vehicles at each timestamp. The movement data of each scene may be expressed as vectors indicating an x-coordinate, a y-coordinate, a velocity (or speed) v, and a heading angle θ of a vehicle included in the scene.

The guide information J may be input to the pre-trained diffusion model 110 to generate a driving scenario τ⁰. The guide information J may include conditions for deriving a realistic driving scenario. As described with reference to FIG. 1, the guide information J may include, but not be limited to, a speed limit of a vehicle, setting of a destination, setting of signal information during driving, conditions for preventing collisions between vehicles, and conditions for positioning a vehicle on a road within a map.

Each piece of movement data may be converted into generated map data x_{GM} and connected to generate a driving scenario τ⁰. That is, a driving scenario τ⁰ in which coordinates move around the ego vehicle may be generated.

The diffusion model 110 may determine one vehicle as the ego vehicle and provide a scene in which a reference coordinate is converted around the ego vehicle. For example, a scene of the driving scenario τ⁰ may be generated centered on a vehicle that has a longest driving distance within the driving scenario τ⁰. The movement data may be generated by cropping a fixed-size region at each timestamp with the ego vehicle of the driving scenario τ⁰ as a center coordinate. For example, a conversion function may be used to convert a coordinate.

In operation 220, the device may infer at least one BEV feature corresponding to at least one piece of generated map data x_{GM} by inputting at least one piece of generated map data x_{GM} included in the driving scenario τ⁰ of the vehicle to a pre-trained neural network.

The pre-trained neural network may be an artificial intelligence (AI) model comprising a plurality of artificial neural network layers. The pre-trained neural network may be and/or may include a BEV Former, a deep neural network (DNN), a convolutional neural network (CNN), a recurrent neural network (RNN), a restricted Boltzmann machine (RBM), a deep belief network (DB N), a bidirectional recurrent deep neural network (BRDNN), deep Q-network or a combination of two or more thereof but is not limited thereto. The pre-trained neural network may, additionally or alternatively, include a software structure other than the hardware structure.

The BEV feature may include values that represent information on surroundings of the vehicle, such as, but not limited to, other vehicles, roads, and/or signals around the ego vehicle. Since surroundings information of the ego vehicle may be embedded in the generated map data x_{GM}, the BEV feature may be inferred based on the generated map data x_{GM} without an input from a camera, for example.

The neural network may be trained and used to infer the BEV feature from the generated map data x_{GM}. Using a pre-trained neural network, the BEV feature may be generated without a multi-view camera image of the ego vehicle, for example. The neural network may be trained so that the BEV feature generated from the generated map data x_{GM} may have substantially similar information to information of a BEV feature generated from a multi-view camera image.

The generated BEV feature may have substantially similar information to the information of the BEV feature generated from the multi-view camera image, and thus, may be used to train a neural network for autonomous driving.

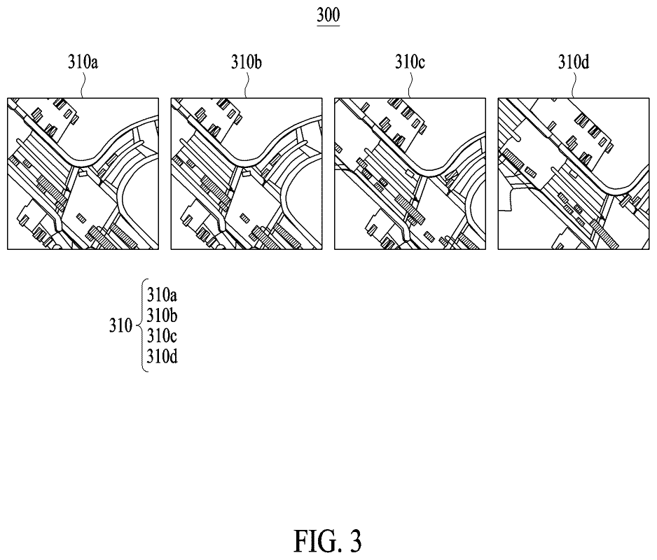

FIG. 3 is an example of a driving scenario generated by a diffusion model, according to an embodiment. Referring to FIG. 3, a driving scenario 300 generated by the diffusion model 110 is illustrated.

The driving scenario 300 may be an end-to-end driving scenario and may be generated in a synthetic form, by converting movement data for each vehicle in a scene at each timestamp into generated map data (e.g., first generated map data 310a, second generated map data 310b, third generated map data 310c, and fourth generated map data 310d, hereinafter referred to as “310”). For example, the movement data may be obtained at a predetermined time interval for a predetermined period of time.

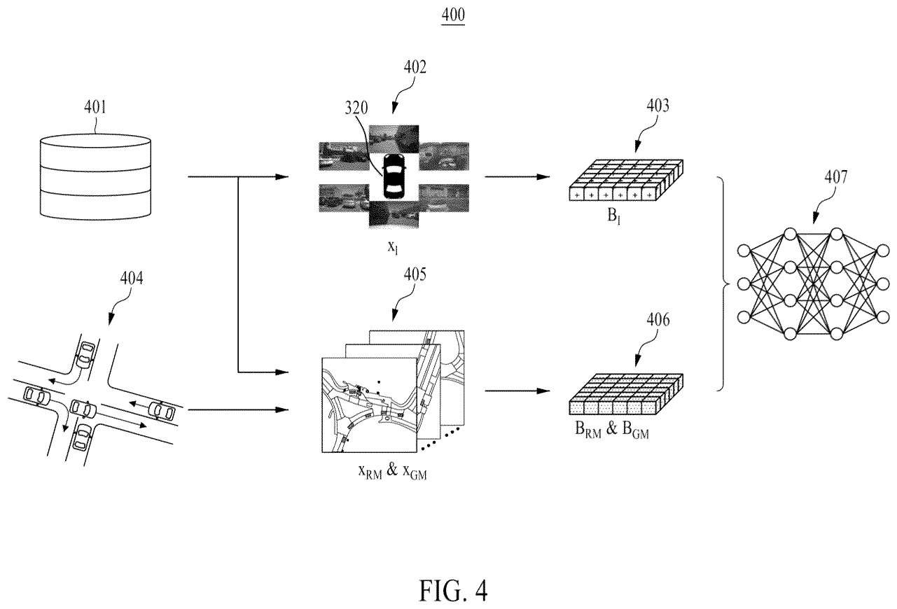

The driving scenario 300 may be generated with a vehicle, which may have a longest driving distance within the driving scenario 300, fixed as a center coordinate. Alternatively, a vehicle with a longest driving distance, among vehicles without a collision, may be set as an ego vehicle 320 (see FIG. 4).

A driving scenario 300 without an ego vehicle 320 set may have a form that displays movement of vehicles based on an absolute coordinate, and when an ego vehicle 320 is set as shown in FIG. 3, the driving scenario 300 may be expressed by converting coordinates of surrounding vehicles and a map based on movement of the ego vehicle 320. For example, a conversion function may be used to convert a coordinate.

Each piece of generated map data 310 included in the driving scenario 300 may be generated based on a map application programming interface (API). The generated map data 310 may be generated by reflecting vectors including one or more elements (e.g., a drivable area, a road section, a lane, a crosswalk, and a sidewalk), focusing on an area of a predetermined size centered on a vehicle. For example, vehicles other than the ego vehicle 320 may be rendered by overlaying the vehicles on the coordinate.

A rotation matrix may be applied to the coordinate around the ego vehicle 320 of the driving scenario 300. A position of the ego vehicle 320 may be placed at a center of the area, and the rotation matrix may be determined according to a rotation angle based on a direction of travel of the ego vehicle 320.

FIG. 4 is a diagram conceptually illustrating training of a neural network for extracting a BEV feature from a synthesized driving scenario, according to an embodiment. Referring to FIG. 4, a training method 400 of a neural network 407 for extracting a BEV feature from a synthesized driving scenario is illustrated.

The neural network 407 may be trained to generate a BEV feature from generated map data that may have substantially similar information to information of a BEV feature generated from a multi-view camera image.

In a device for training, an actual driving scenario may be obtained from a dataset 401. The dataset 401 may include a camera multi-view image x_{I} 402 for the actual driving scenario and may include map data 405 (e.g., a real map data x_{RM} and the generated map data x_{GM}) corresponding to each timestamp of the camera multi-view image x_{I} 402.

The neural network 407 may be trained based on a loss function that may be based on an error between BEV features. The error (loss function) between a BEV feature B_{I} 403 inferred from the camera multi-view image x_{I} 402 and a BEV feature 406 (e.g., a real map data BEV feature B_{RM} and a generated map data BEV feature B_{GM}) inferred from a synthesized driving scenario 404 and the map data 405 may be used to train the neural network 407.

The BEV feature B_{I} 403 may be inferred through a neural network such as, but not limited to, a BEV Former, which may have been trained to extract a BEV feature for the camera multi-view image x_{I} 402. The BEV feature 406 may be inferred by the neural network 407 that may be a training target.

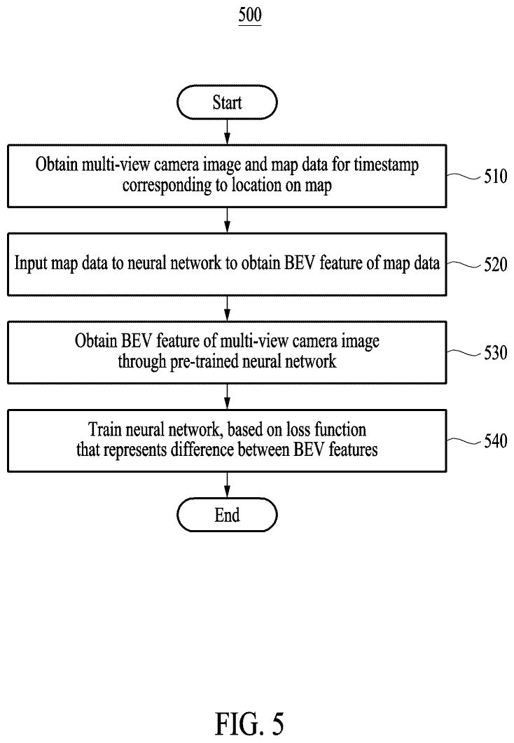

FIG. 5 is a flowchart illustrating a method of training a neural network for inferring a BEV feature from map data, according to an embodiment. Referring to FIG. 5, a method 500 for training a neural network 407 for inferring a BEV feature from map data is illustrated.

In operation 510, a training device may obtain a multi-view camera image x_{I} 402 and real map data x_{RM} for one or more timestamps corresponding to a location on a map and to the multi-view camera image x_{I} 402.

The training device may access a pre-built large-scale dataset, such as, but not limited to, NuScene Data. For example, the multi-view camera image x_{I} 402 and the real map data x_{RM} related to an actual driving scenario may be accessed from the dataset. Alternatively, or additionally, the training device may obtain multi-view camera image x_{I} 402 and the real map data x_{RM} for the timestamp corresponding to the location on the map using one or more sensors. The present disclosure is not limited in this regard.

In operation 520, the training device may input the real map data x_{RM} to a neural network 407 to obtain a real map BEV feature B_{RM} of the real map data x_{RM}.

In operation 530, the training device may obtain a BEV feature B_{I} 403 of the multi-view camera image x_{I} 402 through a pre-trained neural network.

The training device may obtain ground truth of the BEV feature through the pre-trained neural network, which has been pre-trained to extract the BEV feature B_{I} 403 from the multi-view camera image x_{I} 402, and may obtain the real map BEV feature B_{RM} of the real map data x_{RM} from a neural network 407 for use as a training target. The neural network 407 for inferring a real map BEV feature B_{RM} of the real map data x_{RM} may be trained using two (2) or more BEV features obtained from two (2) or more different neural networks.

In operation 540, the training device may train the neural network 407, based on a loss function that may represent a difference between the BEV feature B_{I} 403 and the real map BEV feature B_{RM}.

The neural network pre-trained to extract the BEV feature B_{I} 403 from the multi-view camera image x_{I} 402 may receive, as an input, a multi-view two-dimensional (2D) camera image captured from an ego vehicle 320 and infer a BEV feature B_{I} 403 for a corresponding location.

The training device may calculate an error between a BEV feature B_{I} 403 inferred from a pre-trained neural network and a BEV feature inferred from a neural network 407 that is a training target and train the neural network 407 that is a training target by using a loss function that may represent the error so that a result substantially similar to the BEV feature B_{I} 403 of the pre-trained neural network may be obtained from the neural network 407 for obtaining a real map BEV feature B_{RM} from the real map data x_{RM}.

The training may proceed after setting an initial value of a query of the neural network 407 that is a training target as a query of the pre-trained neural network. The query may be used as is so that an output of the neural network 407 that is a training target may be output in the same size as an output of the pre-trained neural network.

The neural network 407 that is a training target may have a structure including ResNet that may be configured to encode map data and a Transformer that may utilize an output of the RestNet as a key and a value and may encode a BEV feature by setting a query.

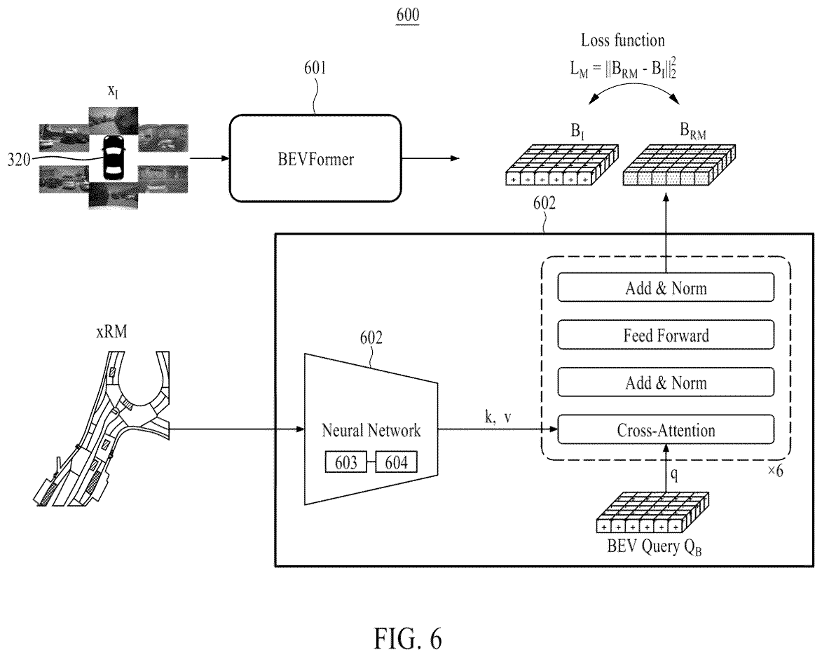

FIG. 6 is a diagram illustrating training of a neural network that infers a BEV feature from map data, according to an embodiment. Referring to FIG. 6, a training process 600 of a neural network 602 that infers a BEV feature B_{RM} from map data x_{RM}.

A neural network BEV Former 601 that is pre-trained may obtain a BEV feature B_{I} 403 from a multi-view camera image x_{I} 402 of an ego vehicle 320. The multi-view camera image x_{I} 402 may be obtained from a dataset 401 and may be based on a real driving scenario.

A neural network 602 that is a training target of the training process 600 may include a ResNet 603 (e.g., a neural network) that may encode the map data x_{RM} and a transformer encoder 604 that may utilize an output of the ResNet as a key k and a value v and may encode the BEV feature B_{RM} by setting, using a BEV query Q_{B} of the neural network 601, an initial query value q.

The multi-view camera image x_{I} 402 of the ego vehicle 320 and map data x_{RM} corresponding to a location on a map may be configured as an input of the neural network 602 and be input to the neural network 602. The key k and the value v, which may be map features, may be generated through the ResNet 603 in order to infer a BEV feature B_{RM} from the map data x_{RM}.

The transformer encoder 604 may use the generated key k and the generated value v as inputs and may use the BEV query Q_{B} of the neural network 601 as a query q for training. As shown in FIG. 6, the transformer encoder 604 may be composed of six (6) blocks. For example, the transformer encoder 604 may include a cross-attention layer, a feed-forward network, and a normalization layer (e.g., Add & Norm) along with residual connections. Through this architecture, the transformer encoder 604 may capture a spatial relationship within map features and generate map data-based BEV feature B_{RM}. However, the present disclosure is not limited in this regard, and the transformer encoder 604 may be composed of less blocks (e.g., five (5) or less blocks and/or layers) or may be composed of more blocks (e.g., seven (7) or more blocks and/or layers).

In an embodiment, a loss of the neural network 602 may be calculated using one or more functions that may include well-known functions for determining a loss of a machine learning model. For example, the loss of the neural network 602 may be calculated using an L2 loss function that may be used to have the map data-based BEV feature B_{RM} generated from the map data x_{RM} by the neural network 602 to be substantially similar to the BEV feature B_{I} 403 generated by the neural network 601 from the multi-view camera image x_{I} 402 of the ego vehicle 320. The L2 loss function may be expressed as an error between the two BEV features and may be represented as an equation similar to Equation 1.

$${L}_{M} = {‖ {B}_{RM} - {B}_{I} ‖}_{2}^{2} \qquad [ Equation 1 ]$$

Referring to Equation 1, Ly may represent the L2 loss of the neural network 602 compared to the BEV feature B_{I} 403 generated by the neural network 601. As used herein, the L2 loss may also be referred to as a mean squared error (MSE) loss function, or a quadratic loss. However, the present disclosure is not limited in this regard, and various other loss functions may be used to train the neural network 602. For example, the loss of the neural network 602 may correspond to, but not be limited to, at least one of a mean absolute error (MAE) loss (L1 loss), an adversarial loss, a cross-entropy loss, or a combination thereof.

Consequently, the neural network 602 that has completed the training process 600 may generate a map based BEV feature B_{RM} without relying on a camera image.

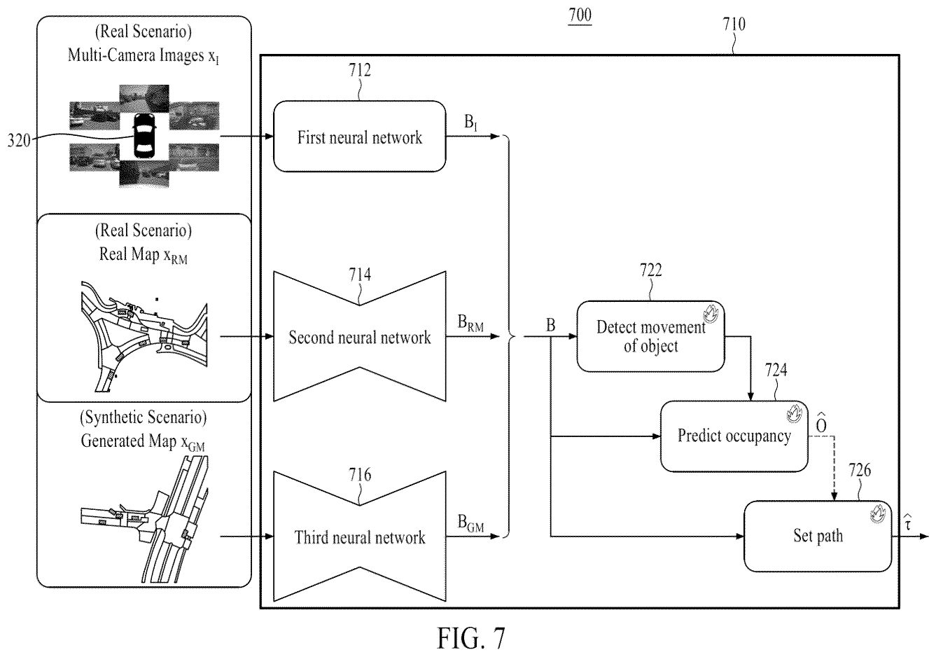

FIG. 7 is a diagram illustrating a method of utilizing, for an end-to-end autonomous driving neural network, a BEV feature inferred from map data 405, according to an embodiment. Referring to FIG. 7, a method 700 of utilizing, for an end-to-end autonomous driving neural network 710, a map based BEV feature inferred from map data is illustrated.

The BEV feature (e.g., a real map data BEV feature B_{RM} and a generated map data BEV feature B_{GM}) inferred from the map data (e.g., a real map data x_{RM} and the generated map data x_{GM}) may be used as additional training data to train the autonomous driving neural network 710.

As shown in FIG. 7, the end-to-end autonomous driving neural network 710 may include a first neural network 712, a second neural network 714, and a third neural network 716. The first to third neural networks 712 to 716 may each be trained in parallel.

The first neural network 712, which may correspond to the neural network 602, may be trained to provide a BEV feature B_{I} inferred from a multi-view camera image x_{I} of the ego vehicle 320. The second neural network 714 may be trained to provide a map-based BEV feature B_{RM} inferred from real map data x_{RM}. The third neural network 716 may be trained to provide a map-based BEV feature B_{GM} inferred from generated map data x_{GM}.

In an embodiment, the BEV features generated by the first to third neural networks 712 to 716 may combined (e.g., concatenated) into a single BEV feature B that may be provided to other components of the end-to-end autonomous driving neural network 710. For example, the end-to-end autonomous driving neural network 710 may further include a movement detection component 722, an occupancy prediction component 724, and a path setting component 726, and the combined BEV feature B may be provided to the components 722 to 726. However, the present disclosure is not limited in this regard, and the BEV features generated by the first to third neural networks 712 to 716 may be combined in other ways prior to being provided to the components 722 to 726. Alternatively or additionally, the BEV features generated by the first to third neural networks 712 to 716 may be provided separately to one or more of the components 722 to 726.

Each of the movement detection component 722, the occupancy prediction component 724, and the path setting component 726 may be and/or may include a neural network trained to provide the output of the corresponding component. However, the present disclosure is not limited in this regard, and one or more components, and their corresponding neural networks, may be combined into a single component.

The movement detection component 722 may be and/or may include a neural network trained to detect movement \hat{M} of one or more objects around (e.g., in a relatively close proximity) to the ego vehicle 320. In an embodiment, the movement detection component 722 may infer the movement \hat{M} using the multi-view camera image x_{I} of the ego vehicle 320 and/or the map-based BEV feature B_{RM} inferred from the real map data x_{RM} by the second neural network 714 as inputs.

The occupancy prediction component 724 may be configured to predict whether a vehicle (e.g., the ego vehicle 320) is on the road. For example, the occupancy prediction component 724 may be and/or may include a neural network trained to predict a spatial occupancy Ô across future frame sequences and may be trained using the BEV feature B_{I} inferred from the multi-view camera image x, of the ego vehicle 320 by the first neural network 712 and/or the movement \hat{M} detected by the movement detection component 722 as inputs.

The path setting component 726 may be and/or may include a neural network that may be trained to set a path \hat{τ} of the ego vehicle 320 using the BEV feature B_{I} inferred from the multi-view camera image x_{I} of the ego vehicle 320 by the first neural network 712, the map-based BEV feature B_{RM} inferred from the real map data x_{RM} by the second neural network 714, and the map-based BEV feature B_{GM} inferred from generated map data x_{GM} (synthesized driving scenario) by the third neural network 716. Alternatively or additionally, the path setting component 726 may further use the spatial occupancy Ô generated by the occupancy prediction component 724 to set the path \hat{τ} of the ego vehicle 320.

As described above, the synthesized driving scenario (e.g., map-based BEV feature B_{GM}) may be used to update the path setting component 726, and a real driving scenario (e.g., map-based BEV feature B_{RM}) using the multi-view camera image x_{I} of the ego vehicle 320 may be trained together with other components (e.g., the movement detection component 722 and the occupancy prediction component 724), so that a performance of an intermediate neural network may be maintained and a performance of the path setting component 726 for setting the path t of the ego vehicle 320 may be maintained and/or enhanced.

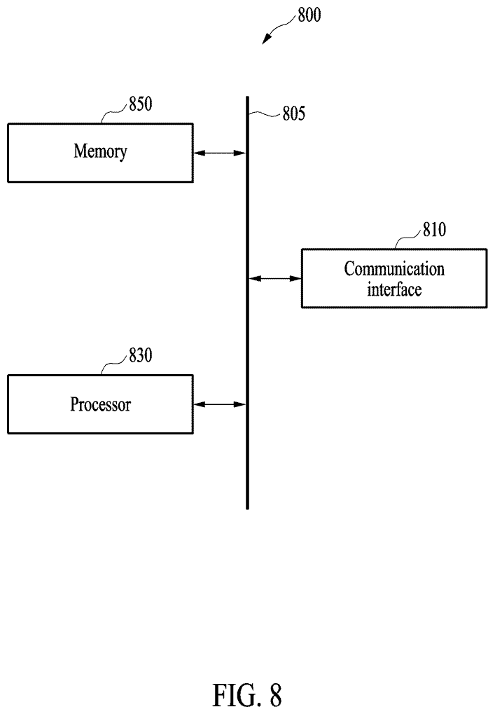

FIG. 8 is a block diagram illustrating a device for inferring a BEV feature from a driving scenario, according to an embodiment.

Referring to FIG. 8, an apparatus 800, according to an embodiment, may include a communication interface 810, a processor 830, and a memory 850. The communication interface 810, the processor 830, and the memory 850 may communicate with each other through a communication bus 805.

The communication interface 810 may receive an instruction for generating a driving scenario 300.

The communication interface 810 may be configured to transmit and/or receive data by wire and/or wirelessly. For example, the communication interface 810 may be implemented as a wireless interface, such as, but not limited to, wireless fidelity (Wi-Fi), Bluetooth™, ZigBee, long range (LoRa), or the like. Alternatively or additionally, the communication interface 810 may be implemented as a wired interface such as, but not limited to, Ethernet, universal serial bus (USB), near-field communication (NFC), or the like. The communication interface 810 may include a user interface for receiving an input from a user (e.g., a keyboard, a mouse, a microphone, or the like). The communication interface may also include a user interface for providing information to the user (e.g., a display, a speaker, or the like).

The processor 830 may generate a driving scenario 300 based on an instruction received via the communication interface 810. The processor 830 may generate a driving scenario 300 that may satisfy guide information J in a pre-trained diffusion model 110. In addition, the processor 830 may infer a BEV feature for map data corresponding to each timestamp of the driving scenario 300 through a pre-trained neural network.

The memory 850 may store a program for performing operations of the processor 830 described above and a variety of information generated in an encoding process. Furthermore, the memory 850 may store a variety of data and programs. The memory 850 may include a volatile memory and/or a non-volatile memory. The memory 850 may include a large-capacity storage medium such as, but not limited to, a hard disk to store a variety of data.

In addition, the processor 830 may perform at least one of the methods described with reference to FIGS. 1 to 7 or an algorithm corresponding to at least one of the methods. The processor 830 may be a hardware-implemented data processing device having a circuit that is physically structured to execute desired operations. The desired operations may include, for example, instructions or code embedded in a program. The processor 830 may be implemented as, for example, a central processing unit (CPU), a graphics processing unit (GPU), or a neural processing unit (NPU). For example, a hardware-implemented data processing device may include, for example, a microprocessor, a CPU, a processor core, a multi-core processor, a multiprocessor, an application-specific integrated circuit (ASIC), and a field-programmable gate array (FPGA).

The processor 830 may execute a program and control the apparatus 800. Program code to be executed by the processor 830 may be stored in the memory 850. Although FIG. 8 depicts the processor 830 as a single processor, the present disclosure is not limited in this regard. For example, the processor 830 may refer to one or more processors 830 that include processing circuitry and may execute individually and/or collectively the program code stored in the memory 850.

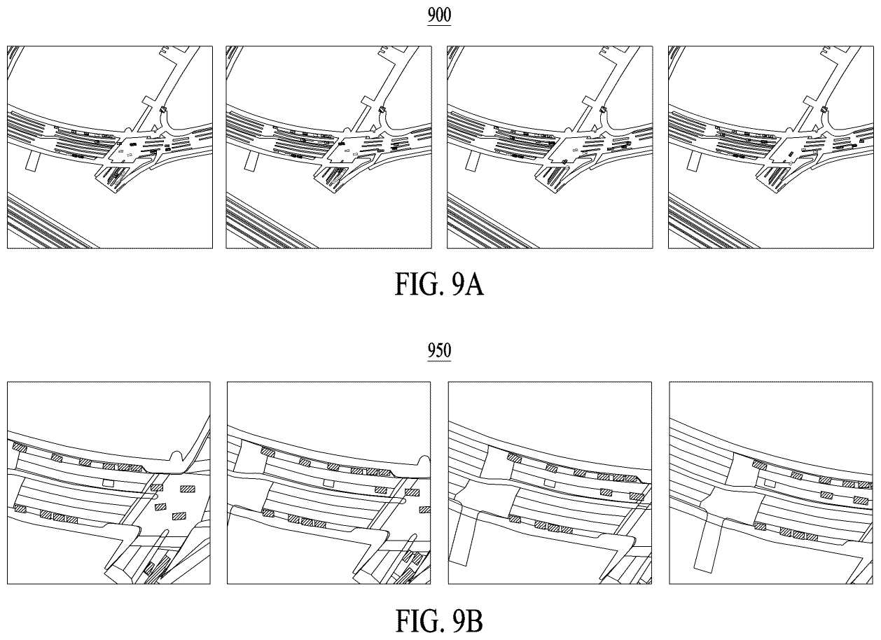

FIGS. 9A and 9B are diagrams illustrating performance of an example of generating a driving scenario 300, according to an embodiment.

FIG. 9A is an example of a driving scenario 900 generated in an absolute coordinate system, and FIG. 9B is an example of a driving scenario 950 generated with an ego vehicle 320 at the center.

When generating a driving scenario 900 based on a diffusion model 110, the driving scenario 900 may be output as in FIG. 9A, without specifying an ego vehicle. The driving scenario 900 of FIG. 9A may be helpful in identifying a path of multiple vehicles but may not be appropriate to utilize for training an autonomous driving neural network.

Both methods may utilize a diffusion model 110, but the possibility of utilizing the methods for training an autonomous driving module may depend on a preprocessing process.

As shown in FIG. 9B, the driving scenario 950 may be utilized for training an autonomous driving neural network by expressing the map data with an ego vehicle 320 set. A method of expressing the map data may be configured to express elements for each area (e.g., a driving area, a road section, a lane, a crosswalk, a sidewalk, or the like) for training an autonomous driving neural network.

A neural network trained to infer a BEV feature from the map data may receive map data such as FIG. 9A as an input and may generate a BEV feature.

The methods according to the embodiments may be recorded in non-transitory computer-readable media including program instructions to implement various operations of the embodiments. The media may also include the program instructions, data files, data structures, or the like alone or in combination. The program instructions recorded on the media may be those specially designed and constructed for the purposes of examples, or they may be of the kind well-known and available to one of ordinary skill in the computer software arts. Examples of non-transitory computer-readable media include magnetic media such as hard disks, floppy disks, and magnetic tape; optical media (e.g., compact-disc read-only memory (CD-ROM) discs and digital versatile discs (DVDs)), magneto-optical media (e.g., optical discs), and hardware devices that may be specially configured to store and perform program instructions, such as, but not limited to, read-only memory (ROM), random-access memory (RAM), flash memory, or the like. Examples of program instructions may include both machine code, such as those produced by a compiler, and files containing high-level code that may be executed by the computer using an interpreter. The above-described hardware devices may be configured to act as one or more software modules in order to perform the operations of the examples, or vice versa.

The software may include a computer program, a piece of code, an instruction, or one or more combinations thereof, to independently or collectively instruct or configure the processing device to operate as desired. Software and/or data may be embodied permanently or temporarily in any type of machine, component, physical or virtual equipment, computer storage medium or device, or in a propagated signal wave for the purpose of being interpreted by the processing device or providing instructions or data to the processing device. The software may also be distributed over network-coupled computer systems so that the software is stored and executed in a distributed fashion. The software and data may be stored by one or more non-transitory computer-readable recording mediums.

While the embodiments are described with reference to a limited number of drawings, it may be apparent to one of ordinary skill in the art that various alterations and modifications in form and details may be made in these embodiments without departing from the spirit and scope of the claims and their equivalents. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

What is claimed is:

1. A method of extracting a bird's eye view (BEV) feature, the method comprising:
generating, from a diffusion model, a driving scenario of a vehicle, based on guide information, the driving scenario comprising at least one piece of map data;
inferring, using a pre-trained neural network, at least one BEV feature corresponding to the at least one piece of map data by inputting the at least one piece of map data to the pre-trained neural network; and
setting a path of an autonomous driving model based on the at least one BEV feature, the autonomous driving model controlling a driving operation of the vehicle.

2. The method of claim 1, wherein the generating of the driving scenario of the vehicle comprises:
obtaining, from the diffusion model for a predetermined time period, movement data corresponding to at least one timestamp, the movement data comprising a location of the vehicle, a speed of the vehicle, and a direction of the vehicle; and
generating the driving scenario by synthesizing map data that displays the movement data on a map, based on the at least one timestamp.

3. The method of claim 1, wherein the generating of the driving scenario of the vehicle comprises:
generating the driving scenario based on the guide information comprising at least one of a maximum speed limit of the vehicle, a destination of the vehicle, or vehicle signal settings during driving of the vehicle.

4. The method of claim 1, wherein the generating of the driving scenario of the vehicle comprises:
generating the driving scenario based on the guide information comprising a weight setting for positioning the vehicle on a road within a map and a setting for maintaining a distance from other vehicles.

5. The method of claim 1, wherein the inferring of the at least one BEV feature comprises:
extracting the at least one BEV feature corresponding to at least one timestamp comprised in the driving scenario.

6. The method of claim 1, further comprising:
obtaining the pre-trained neural network by training a neural network using a loss function based on a difference between a first BEV feature of the map data and a second BEV feature of a multi-view camera image corresponding to the map data.

7. The method of claim 1, further comprising:
training, by using the at least one BEV feature, at least one neural network from among a plurality of neural networks comprising a first neural network configured to detect movement of a surrounding vehicle around the vehicle, a second neural network configured to predict an occupancy of a surrounding road and an operation of the surrounding vehicle, and a third neural network configured to determine a next moving path of the vehicle.

8. The method of claim 7, further comprising:
training the third neural network using a loss function based on a difference between the at least one BEV feature, a first BEV feature of a multi-view camera image, and a second BEV feature of map data corresponding to the multi-view camera image.

9. The method of claim 7, further comprising:
training the first neural network using a first loss function based on a first difference between a first BEV feature of a multi-view camera image and a second BEV feature of map data corresponding to the multi-view camera image; and
training the second neural network using a second loss function based on a second difference between the first BEV feature, the second BEV feature, and a third BEV feature of generated map data corresponding to the multi-view camera image.

10. The method of claim 7, wherein the training of the second neural network comprises:
obtaining the at least one piece of map data by converting a coordinate system around the vehicle; and
inputting the at least one converted piece of map data to the second neural network.

11. A method of training a first neural network for extracting a bird's eye view (BEV) feature, the method comprising:
obtaining a multi-view camera image and map data for a timestamp corresponding to a location on a map;
obtaining a first BEV feature of the map data by inputting the map data to a second neural network;
obtaining a second BEV feature of the multi-view camera image by inputting the multi-view camera image to a third neural network; and
training the first neural network using a loss function based on a difference between the first BEV feature of the map data and the second BEV feature of the multi-view camera image.

12. The method of claim 11, wherein the training of the first neural network comprises:
training the first neural network by inputting a BEV feature query of the first neural network to the third neural network as a query of the third neural network.

13. A device for extracting a bird's eye view (BEV) feature, the device comprising:
one or more processors comprising processing circuitry; and
memory storing instructions,
wherein the instructions, when executed by the one or more processors individually or collectively, cause the device to:
generate, using a diffusion model, a driving scenario of a vehicle based on guide information, the driving scenario comprising at least one piece of map data;
infer, using a pre-trained neural network, at least one BEV feature corresponding to the at least one piece of map data by inputting the at least one piece of map data to the pre-trained neural network; and
set a path of an autonomous driving model based on the at least one BEV feature, the autonomous driving model controlling a driving operation of the vehicle.

14. The device of claim 13, wherein the instructions, when executed by the one or more processors individually or collectively, further cause the device to:
obtain, from the diffusion model for a predetermined time period, movement data corresponding to at least one timestamp, the movement data comprising a location of the vehicle, a speed of the vehicle, and a direction of the vehicle; and
generate the driving scenario by synthesizing map data that displays the movement data on a map, based on the at least one timestamp.

15. The device of claim 13, wherein the instructions, when executed by the one or more processors individually or collectively, further cause the device to:
generate the driving scenario based on the guide information comprising at least one of a maximum speed limit of the vehicle, a destination of the vehicle, or settings of signals of the vehicle during driving.

16. The device of claim 13, wherein the instructions, when executed by the one or more processors individually or collectively, further cause the device to:
generate the driving scenario based on the guide information comprising a weight setting for positioning the vehicle on a road within a map and a setting for maintaining a distance from other vehicles.

17. The device of claim 13, wherein the instructions, when executed by the one or more processors individually or collectively, further cause the device to:
extract the at least one BEV feature corresponding to at least one timestamp comprised in the driving scenario.

18. The device of claim 13, wherein the instructions, when executed by the one or more processors individually or collectively, further cause the device to:
obtain the pre-trained neural network by training a neural network using a loss function based on a difference between a first BEV feature of the map data and a second BEV feature of a multi-view camera image corresponding to the map data.

19. The device of claim 13, wherein the instructions, when executed by the one or more processors individually or collectively, further cause the device to:
train, by using the at least one BEV feature, at least one neural network from among a plurality of neural networks comprising a first neural network configured to detect movement of a surrounding vehicle around the vehicle, a second neural network configured to predict an occupancy of a surrounding road and an operation of the surrounding vehicle, and a third neural network configured to determine a next moving path of the vehicle is trained by using the at least one BEV feature.

20. The device of claim 19, wherein the instructions, when executed by the one or more processors individually or collectively, further cause the device to:
train the third neural network using a loss function based on a difference between the at least one BEV feature, a first BEV feature of a multi-view camera image, and a second BEV feature of map data corresponding to the multi-view camera image.
